(19) United States
(12) Patent Application Publication
(10) Pub. No.: US 2025/0356266 A1
(43) Pub. Date: Nov. 20, 2025

(54) MACHINE LEARNING (ML) MODEL GOVERNANCE VIA PLACEBO DATA INJECTION VALIDATION

(71) Applicant: INTERNATIONAL BUSINESS MACHINES CORPORATION, ARMONK, NY (US)

(72) Inventors: Al Chakra, Apex, NC (US); Leonard James Carcaramo, JR., Kingston, NY (US); John Bouzakis, Wappingers Falls, NY (US); Elpida Tzortzatos, Lagrangeville, NY (US)

(21) Appl. No.: 18/665,658

(22) Filed: May 16, 2024

(51) Int. Cl. G06N 20/20

(52) U.S. Cl. CPC G06N 20/20

(57) ABSTRACT

Aspects of the present disclosure relate to machine learning (ML) model governance. A first ML output can be received from a first version of a ML model based on a first prompt. The first version of the ML model can be trained on placebo data to obtain a second version of the ML model. A second ML output can be received from the second version of the ML model trained on the placebo data based on the first prompt. A validation result can be received based on a comparison between the first ML output and the second ML output.

### BACKGROUND

The present disclosure relates generally to the field of computing, and in particular, to machine learning (ML) model governance.

Artificial Intelligence (AI) is a broad field of computer science aimed at creating machines that match or exceed human intelligence, including perceiving, synthesizing, and inferring information. AI technology is used within many applications, including web search engines, recommendation systems, speech devices, autonomous vehicles, creative tools, and strategy games.

Machine learning (ML) is a branch of AI that relates to constructing mathematical models that automatically learn and improve from experience without being explicitly programmed. That is, ML refers to techniques for training machines to perform specific AI tasks. ML training involves providing an ML algorithm with training data to learn from. Training can refer to the overall process of developing an ML model, or the specific portion of the development process where parameters of the ML model are updated. Training typically aims at finding a set of values of model parameters (e.g., weights) that best describe training data.

### SUMMARY

Aspects of the present disclosure relate to computer program products, systems, and methods for machine learning (ML) model governance via placebo data injection validation. A first ML output can be received from a first version of a ML model based on a first prompt. The first version of the ML model can be trained on placebo data to obtain a second version of the ML model. A second ML output can be received from the second version of the ML model trained on the placebo data based on the first prompt. A validation result can be received based on a comparison between the first ML output and the second ML output.

Additional aspects of the present disclosure are further directed to alternative embodiments for ML model governance via placebo data injection validation. A first set of ML outputs can be received from a first version of a ML model based on a first set of prompts. The first version of the ML model can be trained on placebo data to obtain a second version of the ML model. A second set of ML outputs can be received from the second version of the ML model trained on the placebo data based on the first set of prompts. A validation result can be received based on a comparison between the first set of ML outputs and the second set of ML outputs.

Additional aspects of the present disclosure are further directed to alternative embodiments for ML model governance. A first ML output can be received from a first version of a ML model based on a first prompt. The first version of the ML model can be trained on placebo data to obtain a second version of the ML model. A second ML output can be received from the second version of the ML model trained on the placebo data based on the first prompt. The first version of the ML model can be adjusted based the first ML output and the second ML output being different.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a high-level block diagram illustrating an example computer system and network environment that can be used in implementing one or more of the methods, tools, modules, and any related functions described herein, in accordance with embodiments of the present disclosure.

FIG. 2 is a block diagram illustrating an example network environment including a machine learning (ML) model governance system, in accordance with embodiments of the present disclosure.

FIG. 3 is a flowchart illustrating an example method for ML model governance using placebo data injection validation, in accordance with embodiments of the present disclosure.

FIG. 4 is a flowchart illustrating another example method for ML model governance using placebo data injection validation, in accordance with embodiments of the present disclosure.

FIG. 5 is a flowchart illustrating an example method for ML model adjustment based on a placebo data injection validation result, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of computing, and more particularly, to machine learning (ML) model governance via placebo data injection validation. While the present disclosure is not necessarily limited to such applications, various aspects of the disclosure may be appreciated through a discussion of various examples using this context.

As discussed above, Artificial Intelligence (AI) is a broad field of computer science aimed at creating machines that match or exceed human intelligence, including perceiving, synthesizing, and inferring information. AI technology is used within many applications, including web search engines, recommendation systems, speech devices, autonomous vehicles, creative tools, and strategy games.

Machine learning (ML) is a branch of AI that relates to constructing mathematical models that automatically learn and improve from experience without being explicitly programmed. That is, ML refers to techniques for training machines to perform specific AI tasks. ML training involves providing an ML algorithm with training data to learn from. Training can refer to the overall process of developing an ML model, or the specific portion of the development process where parameters of the ML model are updated. Training typically aims at finding a set of values of model parameters (e.g., weights) that best describe training data.

Training can occur in a supervised manner, where the ML model learns based on labeled training data. In supervised machine learning, a training dataset typically has labels for both inputs and corresponding output values. This enables the ML model to learn functions that map inputs to outputs, thereby enabling the ML model to make predictions on unseen data.

Training can also occur in a semi-supervised or unsupervised manner, where little to no labels are associated with training data the ML algorithm learns from. Unsupervised learning enables models to discover underlying patterns or structures (e.g., features used for predictions), such as clustering. In semi-supervised learning, a small amount of labeled data in combination with a large amount of unlabeled data can be injected during training, realizing the benefits of both supervised and unsupervised machine learning training methods.

Other manners for training ML models exist, such as reinforcement learning. Within reinforcement learning frameworks, ML algorithms learn by taking actions within an environment to maximize reward. This learning typically involves trial and error, where ML agents improve their policy over time based on feedback (e.g., reward and punishment) they receive after each action.

The increased adoption of ML models for production workloads creates new possibilities and opportunities that have and will continue to bring value to organizations globally. However, when an ML model is deployed into a live production environment and is configured to continuously learn and make predictions/recommendations that lead to operational changes to the organization's systems using real time operational data (e.g., training data), there is unpredictability in how the ML model will evolve as it learns.

For any given type of operational data, there may be inputs that should have no impact on a ML model's predictions/recommendations. Accordingly, if there are situations where these inputs begin impacting the ML model's predictions/recommendations, hallucinations (e.g., or other adverse ML outputs) can occur resulting from degraded performance of the ML model. This can jeopardize business continuity if the ML outputs provided by the ML model negatively impact the organization's systems.

ML models can be validated using historical operational data prior to deployment, but since it is unknown exactly how new real-time operational data will impact the ML model when it is deployed to production, there is risk that inputs that should have a benign effect on the ML model will impact the ML model (e.g., update parameters of the ML model) in a negative manner and potentially result in degradation of the ML model. This degradation may not be realized until the organization's business continuity has already been compromised.

The following description provides examples of embodiments of the present disclosure, and variations and substitutions may be made in other embodiments. Several examples will now be provided to further clarify various aspects of the present disclosure.

Example 1: A computer-implemented method that comprises receiving a first ML output from a first version of a ML model based on a first prompt. The method further comprises training the first version of the ML model on placebo data to obtain a second version of the ML model. The method further comprises receiving a second ML output from the second version of the ML model trained on the placebo data based on the first prompt. The method further comprises receiving a validation result based on a comparison between the first ML output and the second ML output.

The above limitations advantageously enable the validation of an ML model using placebo data injection validation. Placebo data injection validation enables ML model validation using placebo data that should not impact ML model outputs. Thus, if a validation result indicates that the second version of the ML model trained on placebo data returned a different ML output than the first version of the ML model, degradation of the first version of the ML model can be detected. This can enable proactive modification of the first version of the ML model, thereby improving accuracy of the ML model. ML model accuracy can be improved by reducing adverse model parameter changes and reducing adverse model responses (e.g., hallucinations) based on received placebo data injection validation results. ML model validation results can be reported to ML model administrators/engineers such that the ML model can be tuned/updated (e.g., by modifying hyperparameters and parameters of the ML model) as needed to improve ML model accuracy. Aspects of the present disclosure improve the ML model validation process by accurately detecting ML model degradation.

Example 2: The limitations of Example 1, where training the first version of the ML model to obtain the second version of the ML model, receiving the second ML output, and receiving the validation result are completed in response to determining that a condition is met for performing a placebo data injection validation method.

The above limitations advantageously enable conditions to be set (e.g., scheduled or dynamically determined) that dictate a frequency in which placebo data injection validation occurs. Such conditions can be set by a user or learned by the system (e.g., a secondary ML model). This enables placebo data injection validation intervals to execute in a customized manner appropriate for a given ML model. As placebo data injection validation consumes processing time and computing resources, selecting a placebo data injection validation interval that is not too short (e.g., too frequent) conserves computing resources and time. Conversely, selecting/determining a placebo data injection validation interval that is short enough (e.g., frequent enough) to detect ML model degradation prior to the ML model drifting into a state/version where it may be harder to detect the cause(s) of degradation may improve ML model accuracy and reduce costs associated with ML model maintenance/re-training.

Example 3: The limitations of Example 2, where determining that the condition is met for performing the placebo data injection validation method includes determining that the first version of the ML model was updated during a first training interval. The above limitations advantageously enable placebo data injection validation to occur in response to the first version of the ML model being updated during a first training interval. Thus, any changes made to the first version of the ML model can be validated to determine whether the first version of the ML model degraded or was otherwise negatively affected during the first training interval. This can enable detection of ML model degradation prior to the ML model drifting into a state/version where it may be harder to detect the cause(s) of degradation.

Example 4: The limitations of any of Examples 2-3, where determining that the condition is met for performing the placebo data injection validation method includes determining that the first version of the ML model has an ML model parameter change during a last training update that satisfies a parameter change threshold. The above limitations advantageously enable placebo data injection validation to occur in response to determining that an ML model parameter change satisfies a threshold. Thus, if a given ML model parameter change is significant (e.g., satisfies the threshold), the ML model can be validated to determine whether the first version of the ML model degraded or was otherwise negatively affected as a result of the ML model parameter change. This can enable detection of ML model degradation prior to the ML model drifting into a state/version where it may be harder to detect the cause(s) of degradation.

Example 5: The limitations of any of Examples 1-4, where the validation result is an unfavorable validation result based on the first ML output and second ML output being different. The above limitations advantageously enable reporting the unfavorable validation result to users and/or devices associated with the ML model. The unfavorable validation result can be reported to ML model administrators/engineers such that the ML model can be tuned/updated (e.g., by modifying hyperparameters and parameters of the ML model) as needed to improve ML model accuracy.

Example 6: The limitations of Example 5, where the method further comprises adjusting, based on receiving the unfavorable validation result, the first version of the ML model. The above limitations advantageously enable the modification of the first version of the ML model based on receiving the unfavorable validation result to attempt to improve accuracy of the first version of the ML model.

Example 7: The limitations of Example 6, where the method further comprises determining a specific previous version that the first version of the ML model should be reverted to and reverting the first version of the ML model to the specific previous version. The above limitations advantageously enable the first version of the ML model to be reverted to a previous version. The previous version may produce higher quality and/or higher accuracy ML outputs. The previous version to be reverted to can be selected to have a favorable validation result. Thus, the selected previous version may already be considered validated.

Example 8: The limitations of Example 6, where the method further comprises analyzing the first version of the ML model with respect to the second version of the ML model trained on placebo data to determine at least one ML model parameter that changed between the first version and the second version, selecting a ML model parameter of the at least one ML model parameter that changed between the first version of the ML model and the second version of the ML model trained on placebo data within the first version of the ML model, and adjusting the selected ML model parameter of the first version of the ML model to generate a third version of the ML model. The above limitations advantageously enable modification of the first version of the ML model to improve accuracy of the ML model. By modifying a parameter of the first version of the model that was identified as being changed in the second version of the model trained on placebo data, potential adverse changes that resulted in the unfavorable validation result can be corrected, improving ML model accuracy.

Example 9: The limitations of Example 8, where the third version of the ML model is implemented into a live production environment. The above limitations advantageously enable the third (e.g., modified) version of the ML model to be used within a production environment, such as a business, personal, or enterprise setting. Thus, a version of the ML model presumed to be more accurate can be used to generate future ML outputs, thereby improving ML model use by users.

Example 10: A system comprising one or more processors and one or more computer-readable storage media collectively storing program instructions which, when executed by the one or more processors, are configured to cause the one or more processors to perform the method according to any of Examples 1-9. The system of Example 10 realizes the benefits described with respect to Examples 1-9. The system of Example 10 can advantageously be implemented into a variety of computing devices.

Example 11: A computer program product comprising one or more computer readable storage media, and program instructions collectively stored on the one or more computer readable storage media, the program instructions comprising instructions configured to cause one or more processors to perform the method according to any of Examples 1-9. The computer program product of Example 11 realizes the benefits described with respect to Examples 1-9. The computer program product of Example 11 can advantageously be implemented into a variety of computer program products.

Example 12: A computer-implemented method that comprises receiving a first set of ML outputs from a first version of a ML model based on a first set of prompts. The method further comprises training the first version of the ML model on placebo data to obtain a second version of the ML model. The method further comprises receiving a second set of ML outputs from the second version of the ML model trained on the placebo data based on the first set of prompts. The method further comprises receiving a validation result based on a comparison between the first set of ML outputs and the second set of ML outputs.

The above limitations advantageously enable the validation of an ML model using placebo data injection validation. Placebo data injection validation enables ML model validation using placebo data that should not impact ML model outputs. Thus, if a validation result indicates that the second version of the ML model trained on placebo data returned a different ML output than the first version of the ML model, degradation of the first version of the ML model can be detected. This can enable proactive modification of the first version of the ML model, thereby improving accuracy of the ML model. ML model accuracy can be improved by reducing adverse model parameter changes and reducing adverse model responses (e.g., hallucinations) based on received placebo data injection validation results. ML model validation results can be reported to ML model administrators/engineers such that the ML model can be tuned/updated (e.g., by modifying hyperparameters and parameters of the ML model) as needed to improve ML model accuracy. Further, because the above limitations utilize a set of prompts (e.g., and respective sets of ML outputs), accuracy of the validation of the first version of the ML model can be improved based on comparison between multiple ML outputs received from respective versions of the ML model.

Example 13: The limitations of Example 12, where the validation result is an unfavorable validation result based on a threshold number of ML outputs being different between the first set of ML outputs and the second set of ML outputs. The above limitations advantageously enable reporting the unfavorable validation result to users and/or devices associated with the ML model. The unfavorable validation result can be reported to ML model administrators/engineers such that the ML model can be tuned/updated (e.g., by modifying hyperparameters and parameters of the ML model) as needed to improve ML model accuracy. Further, because the unfavorable validation result is based on a threshold number of ML outputs being different, accuracy of the validation result is enhanced. For example, a single ML output comparison may be a false positive (e.g., the ML models may have produced the same output by chance). Similarly, a single ML output comparison may be a false negative (e.g., where the ML models may have produced different outputs despite the second version of the model not degrading). Comparison of multiple ML outputs using a threshold for validation classification can reduce false positive validation results and false negative validation results, thereby improving validation accuracy.

Example 14: The limitations of Example 13, where the method further comprises adjusting, based on receiving the unfavorable validation result, the first version of the ML model to obtain a third version of the ML model, performing a second placebo data injection validation method on the third version of the ML model to receive a second validation result, and implementing the third version of the ML model into a live production environment based on the second validation result being a favorable validation result. The above limitations advantageously realize the benefits described with respect to Examples 12-13. However, the above limitations further enable the ML model to be adjusted to improve the ML model accuracy. Furthermore, the new version of the ML model can be re-validated to ensure the new version is accurate. Once re-validated, the new version can be implemented into a live production environment, enabling users to benefit from the improved ML model.

Example 15: A system comprising one or more processors and one or more computer-readable storage media collectively storing program instructions which, when executed by the one or more processors, are configured to cause the one or more processors to perform the method according to any of Examples 12-14. The system of Example 15 realizes the benefits of Examples 12-14. The system of Example 15 can advantageously be implemented into a variety of computing devices.

Example 16: A computer program product comprising one or more computer readable storage media, and program instructions collectively stored on the one or more computer readable storage media, the program instructions comprising instructions configured to cause one or more processors to perform the method according to any of Examples 12-14. The computer program product of Example 16 realizes the benefits of Examples 12-14. The computer program product of Example 16 can advantageously be implemented into a variety of computer program products.

Example 17: A computer-implemented method that comprises receiving a first ML output from a first version of a ML model based on a first prompt. The method further comprises determining that a condition is met for performing placebo data injection validation, where the condition includes determining that the first version of the ML model was updated during a first training interval. The method further comprises performing the placebo data injection validation by training the first version of the ML model on placebo data to obtain a second version of the ML model, receiving a second ML output from the second version of the ML model trained on the placebo data based on the first prompt, and receiving an unfavorable validation result based on a comparison between the first ML output and the second ML output. The method further comprises, in response to receiving the unfavorable validation result, adjusting the first version of the ML model. Adjusting the first version of the ML model includes analyzing the first version of the ML model with respect to the second version of the ML model trained on placebo data to determine at least one ML model parameter that changed between the first version and the second version, selecting a ML model parameter of the at least one ML model parameter that changed between the first version of the ML model and the second version of the ML model trained on placebo data within the first version of the ML model, and adjusting the selected ML model parameter of the first version of the ML model to generate a third version of the ML model. The method further comprises implementing the third version of the ML model in a live production environment. The above limitations realize the technical benefits described with respect to Examples 1-3, 5, and 8-9.

Example 18: A system comprising one or more processors and one or more computer-readable storage media collectively storing program instructions which, when executed by the one or more processors, are configured to cause the one or more processors to perform the method according to Example 17. The system of Example 18 realizes the benefits of Examples 1-3, 5, and 8-9. The system of Example 18 can advantageously be implemented into a variety of computing devices.

Example 19: A computer program product comprising one or more computer readable storage media, and program instructions collectively stored on the one or more computer readable storage media, the program instructions comprising instructions configured to cause one or more processors to perform the method according to Example 17. The computer program product of Example 19 realizes the technical benefits described with respect to Examples 1-3, 5, and 8-9. The computer program product of Example 19 can advantageously be implemented into a variety of computer program products.

Example 20: A system comprising one or more processors and one or more computer-readable storage media collectively storing program instructions which, when executed by the one or more processors, are configured to cause the one or more processors to perform a method. The method comprises receiving a first machine learning (ML) output from a first version of a ML model based on a first prompt. The method further comprises training the first version of the ML model on placebo data to obtain a second version of the ML model. The method further comprises receiving a second ML output from the second version of the ML model trained on the placebo data based on the first prompt. The method further comprises adjusting the first version of the ML model based the first ML output and the second ML output being different. The above limitations realize the technical advantages discussed with respect to Examples 1 and 6.

Example 21: The limitations according to Example 20, where adjusting the first version of the ML model comprises determining a specific previous version that the first version of the ML model should be reverted to and reverting the first version of the ML model to the specific previous version. The above limitations realize the technical advantages discussed with respect to Examples 1, 6, and 7.

Example 22: The limitations according to Example 20, where adjusting the first version of the ML model comprises analyzing the first version of the ML model with respect to the second version of the ML model trained on the placebo data to determine at least one ML model parameter that changed between the first version and the second version, selecting a ML model parameter of the at least one ML model parameter that changed between the first version of the ML model and the second version of the ML model trained on the placebo data within the first version of the ML model, and adjusting the selected ML model parameter of the first version of the ML model to generate a third version of the ML model. The above limitations realize the technical advantages discussed with respect to Examples 1, 6, and 8.

Aspects of the present disclosure can be implemented in a variety of technical use cases. The following use cases are merely exemplary and are not intended to limit the scope of the disclosure.

In a first use case, a z/OS® Workload Manager (WLM) governs the priority of tasks running across a z/OS® sysplex through a set of policies in a service definition. In embodiments, an ML model (e.g., a first version of an ML model) can be implemented within z/OS® WLM to enable the WLM policies to be dynamically updated in real-time based on operational training data such that the WLM service definition is being continuously improved to meet the organization's Service Level Agreement (SLA). If operational data that is supposed to be ignored by the ML model starts impacting the ML model as it learns, the ML model may begin to output incorrect recommendations/predictions which could degrade system performance and jeopardize business continuity. Aspects of the present disclosure can address the above-referenced complications via placebo data injection validation. That is, the first version of the ML model configured to dynamically update WLM policies can be validated/updated via placebo data injection validation according to Examples 1-22 discussed above.

In a second use case, a z/OS® Enterprise Networking Solutions (ENS) (e.g., a z/OS® operating system component) supports networking on the platform. An ML model (e.g., a first version of an ML model) can be implemented to recommend a suitable (e.g., best) network protocol for new connections and transmissions based on training on historical connections and transmissions (e.g., with similar characteristics). There may be some network connections and transmissions with certain characteristics that should not impact the ML model as it learns from real-time network connection and transmission data. If this network connection and transmission data starts impacting the ML model as it learns, it could cause the ML model to output adverse recommendations/predictions, which could degrade system performance and jeopardize business continuity. Aspects of the present disclosure can address the above-referenced complications via placebo data injection validation. That is, the first version of the ML model configured to recommend suitable network protocols can be validated/updated via placebo data injection validation according to Examples 1-22 discussed above.

In a third use case, a z/OS® System Management Facility (SMF) enables real-time recording of system usage information in a standardized binary format. A ML model (e.g., a first version of an ML model) can be implemented to make operational recommendations/predictions in near real-time based on data read from SMF records. Some SMF record types and subtypes may be irrelevant to the ML model's goals and objectives and therefore should have a benign effect on the ML model as it learns. If these irrelevant SMF record types and subtypes start impacting the ML model, the ML model could start outputting adverse recommendations/predictions which could degrade system performance and jeopardize business continuity. Aspects of the present disclosure can address the above-referenced complications via placebo data injection validation. That is, the first version of the ML model configured to make operational recommendations/predictions based on data read from SMF records can be validated/updated via placebo data injection validation according to Examples 1-22 discussed above.

In a fourth use case, z/OS® maintains a system log that aggregates all messages created by system components and installed software products. A ML model (e.g., a first version of an ML model) can be implemented to make operational recommendations/predictions based on the occurrence of specific messages consumed from real-time system log data. As the ML model learns from real-time system log data, there may be some messages that should have no impact on the ML model. If these messages start impacting the ML model, the ML model could start providing adverse recommendations/predictions which could degrade system performance and jeopardize business continuity. Aspects of the present disclosure can address the above-referenced complications via placebo data injection validation. That is, the first version of the ML model configured to make operational recommendations/predictions based on the occurrence of specific messages consumed from real-time system log data can be validated/updated via placebo data injection validation according to Examples 1-22 discussed above.

In a fifth use case, banks employ ML models (e.g., a first version of an ML model) to detect fraudulent activity for the transactions that they process. These ML models may continuously learn from transactional data as the bank processes it. Certain transactional data should not impact these ML models as they learn. If irrelevant transactional data starts impacting the ML model's predictions/recommendations, it could degrade the performance of the ML models, which could potentially result in increased false positives and even fraudulent transactions going undetected. Both of these scenarios could ultimately lead to loss of business due to impacted customers. Aspects of the present disclosure can address the above-referenced complications via placebo data injection validation. That is, the first version of the ML model configured to detect fraudulent activity based on historical transactional training data can be validated/updated via placebo data injection validation according to Examples 1-22 discussed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

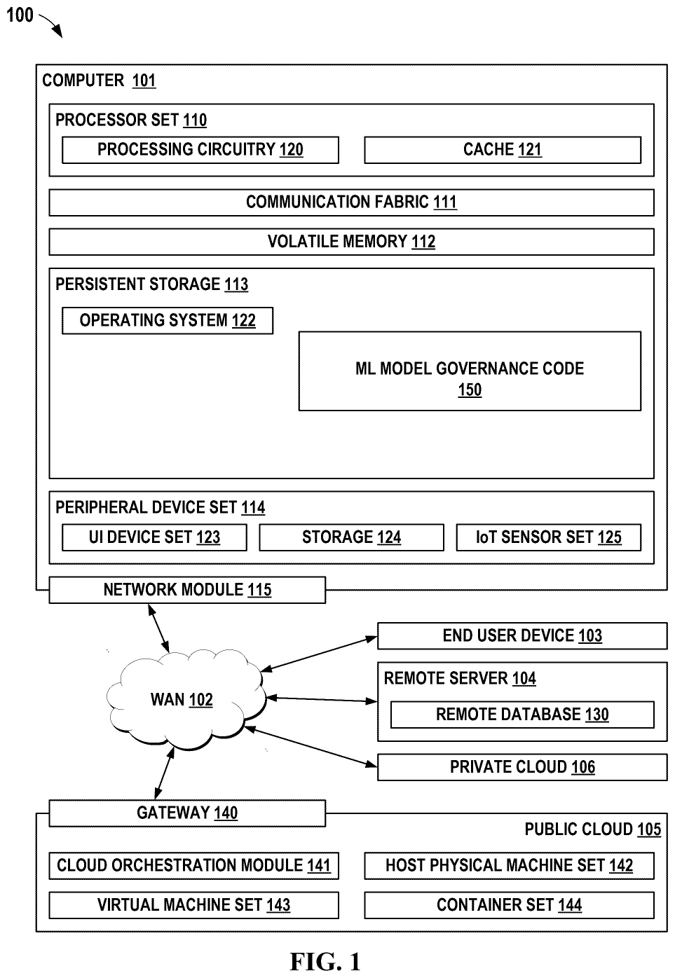

FIG. 1 is a high-level block diagram illustrating an example computing environment 100 that can be used in implementing one or more of the methods, tools, modules, and any related functions described herein, in accordance with embodiments of the present disclosure. Computing environment 100 contains an example of an environment for the execution of at least some of the computer code involved in performing the inventive methods, such as ML model governance code 150. In addition, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and ML model governance code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some or all of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in ML model governance code 150 in persistent storage 113.

Communication fabric 111 includes the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in ML model governance code 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, mixed reality (MR) headset, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

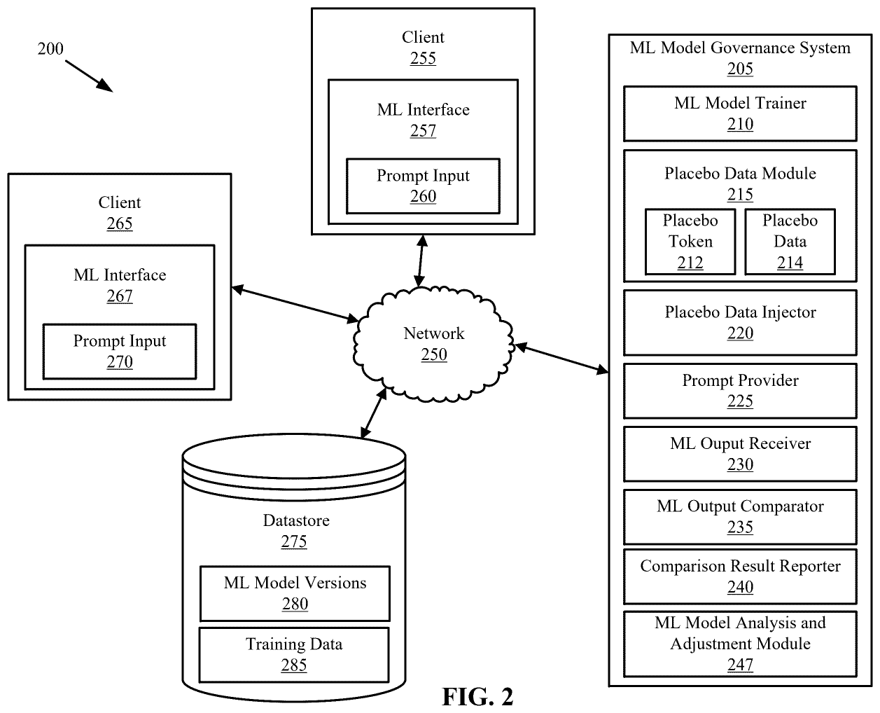

Referring now to FIG. 2, shown is a block diagram illustrating an example network environment 200 in which illustrative embodiments of the present disclosure can be implemented. The network environment 200 includes a machine learning (ML) model governance system (MMGS) 205, clients 255 and 265, and a datastore 275, each of which can be communicatively coupled for intercomponent interaction via a network 250. In embodiments, the network 250 can be the same as, or substantially similar to, WAN 102 of FIG. 1. In embodiments, the clients 255/265 and MMGS 205 can be the same as, or substantially similar to, computer 101, remote server 104, peripheral device set 114, and/or EUD 103 of FIG. 1. In embodiments, datastore 275 can be the same as, or substantially similar to, remote database 130, persistent storage 113, and/or storage 124 of FIG. 1.

The MMGS 205 can be configured to govern ML model(s). In particular, the MMGS 205 can be configured to validate ML models via placebo data injection validation. Placebo data injection validation includes training a ML model (e.g., a first version of the ML model) with placebo data to obtain a second version of the ML model trained on the placebo data. Placebo data injection validation further includes comparing ML outputs (e.g., a first ML output and a second ML output) between the original version (e.g., first version) of the ML model and the second version of the ML model trained on placebo data based on the same (or substantially similar) prompts. The MMGS 205 can also be configured to report validation results and/or update ML models based on placebo data injection validation results.

The MMGS 205 includes a ML model trainer 210, a placebo data module 215, a placebo data injector 220, a prompt provider 225, an ML output receiver 230, an ML output comparator 235, a comparison result reporter 240, and a ML model analysis and adjustment module 247. The functionalities of the ML model trainer 210, placebo data module 215, placebo data injector 220, prompt provider 225, ML output receiver 230, ML output comparator 235, comparison result reporter 240, and ML model analysis and adjustment module 247 can be processor-executable instructions that can be executed by a dedicated or shared processor using received inputs.

In embodiments, components/functionalities of the MMGS 205 can be distributed across different computing components and/or resources over network 250. For example, each individual component and/or combinations of components depicted in FIG. 2 can be implemented as microservices. As another example, components and/or combinations thereof depicted in FIG. 2 can be containerized to bundle related applications and dependencies together for distribution over network 250.

ML model trainer 210 can be configured to perform ML model training. ML model training generally refers to providing ML models training data 285 such that the ML models can learn from the training data 285 (e.g., update model parameters based on the training data 285). ML model training can occur during training intervals (e.g., via batch training) or continuously. ML model trainer 210 can be configured to train one or more ML models using any suitable type of training data. For example, ML model trainer 210 can train ML models using operational training data (e.g., enterprise data). In embodiments, the type of training data ML model trainer 210 utilizes depends on the type of training that the ML model trainer 210 implements. For example, in supervised learning embodiments, ML model trainer 210 provides labeled training data to the ML model to learn from. In unsupervised or semi-supervised embodiments, ML model trainer 210 provides training data to ML models with little to no labels for inputs and corresponding outputs.

The ML model trainer 210 can be configured to train ML models in any suitable manner. In embodiments, ML model trainer 210 can be configured to perform training in a supervised manner, where the ML model learns based on labeled training data. In supervised machine learning, a training dataset typically has labels for both inputs and corresponding output values. This enables the ML model to learn functions that map inputs to outputs, thereby enabling the ML model to make predictions on unseen data. The ML model trainer 210 can also be configured to perform training in a semi-supervised or unsupervised manner, where little to no labels are associated with training data the ML algorithm learns from. Unsupervised learning enables ML models to discover underlying patterns or structures (e.g., features used for predictions), such as clustering. In semi-supervised learning, a small amount of labeled data in combination with a large amount of unlabeled data can be injected during training, realizing the benefits of both supervised and unsupervised machine learning training methods. The ML model trainer 210 can also be configured to perform training via reinforcement learning. Within reinforcement learning frameworks, ML algorithms learn by taking actions within an environment to maximize reward. This learning typically involves trial and error, where ML agents improve their accuracy over time based on feedback (e.g., reward and punishment) they receive after each action. In embodiments, combinations of different training frameworks can be implemented into the same ML model.

“Training a ML model” (or a specific ML model version) can relate to performing direct training (e.g., where training is performed directly by one or more components of MMGS 205) or indirect training (e.g., where the MMGS 205 causes another system, component, application, etc. to perform training). Thus, training an ML model can refer to directly training an ML model or otherwise causing the ML model to be trained.

Hyperparameters and parameters of the ML model to be trained can vary. Hyperparameters are a type of high-level parameter that controls a learning algorithm for the ML model. Hyperparameters are typically regarded as “external” to a ML model, as they control the training process, but are not affected during the training process. In contrast, ML model parameters (as opposed to hyperparameters) can be updated during ML training. Values for hyperparameters and parameters can be set by an ML model administrator or engineer. These values can be updated over time based on trial and error, training processes, and/or via other algorithms (e.g., other ML models).

Machine learning algorithms that can be governed using the described techniques include decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, generative adversarial networks (GANs), and/or other machine learning techniques.

More specifically, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

In embodiments, the ML models can include ML prediction engines and/or ML recommendation engines. These ML models can be configured to provide predictions and/or recommendations in response to requests (e.g., prompts) from users. The predictions and/or recommendations can be generated by a trained ML model based on historical training data 285. In embodiments, prediction and/or recommendation engines can include an ensemble ML model. An ensemble ML model is a type of ML model that couples multiple individual ML models (e.g., ML pipelines) together for cooperatively processing inputs to obtain ML outputs (e.g., providing recommendations and/or predictions). ML model governance techniques described herein can be applied to one or more ensemble ML models and/or individual ML models that make up ensemble ML models.

In some embodiments, the MMGS 205 does not necessarily have to perform training. For example, the MMGS 205 can be configured to obtain a trained ML model. In embodiments, MMGS 205 only performs partial training. That is, a trained ML model can be obtained by the MMGS 205 and the ML model trainer 210 may only update/train a specific portion (e.g., specific parameters, specific layers, etc.) of the trained ML model.

Upon obtaining a trained ML model, clients 255 and 265 can be configured to provide prompts to the ML model. As discussed herein, a “prompt” refers to an input that requests or otherwise causes an ML output. For example, in the context of a weather prediction ML model, a prompt may include: “What is the weather for this afternoon?” As another example, in the context of a product recommendation ML model, a prompt may include: “Please provide me with a list of shoes that match my style.” Prompts can be provided as words, sentences, and/or paragraphs. Prompts can include any type of alphanumeric characters and/or symbols. Prompts may be provided as questions or statements. In embodiments, prompts may include images or data of other formats (e.g., portable document format (pdf), scalable vector graphics (SVG), hypertext markup language (HTML), XLS, etc.). Prompts can request ML output results in any suitable format. For example, a first prompt may request data in a textual format, a second prompt may request data in an image format, a third prompt may request data in an HTML format, and a fourth prompt may request data in an XLS format.

Clients 255 and 265 can provide prompts via respective prompt inputs 260 and 270 on respective ML interfaces 257 and 267. ML interfaces 257, 267 can enable respective clients 255, 265 to access a trained ML model (e.g., ML model versions 280 of datastore 275). For example, trained ML models can be integrated into (e.g., or remotely accessible by) one or more applications and/or web engines, and ML interfaces 257 and 267 may be application and/or web engine interfaces that allow users of clients 255 and 265 to use the trained ML models. ML interfaces 257, 267 enable users to input alphanumeric characters and/or symbols in as prompt inputs 260, 270 that request or otherwise result in ML outputs. For example, a first user of client 255 can input a first prompt into prompt input 260. An ML model can then be configured to provide a first ML output as a response to the first prompt. As another example, a second user of client 265 can input a second prompt into prompt input 270. An ML model (e.g., the same, or a different, ML model) can then be configured to provide a second ML output as a response to the second prompt. In embodiments, prompt provider 225 can be configured to transmit prompts received from prompt inputs 260, 270 to a respective trained ML model. Though the implementation depicted in FIG. 2 includes two clients 255 and 265, in embodiments, any suitable number of clients can be implemented.

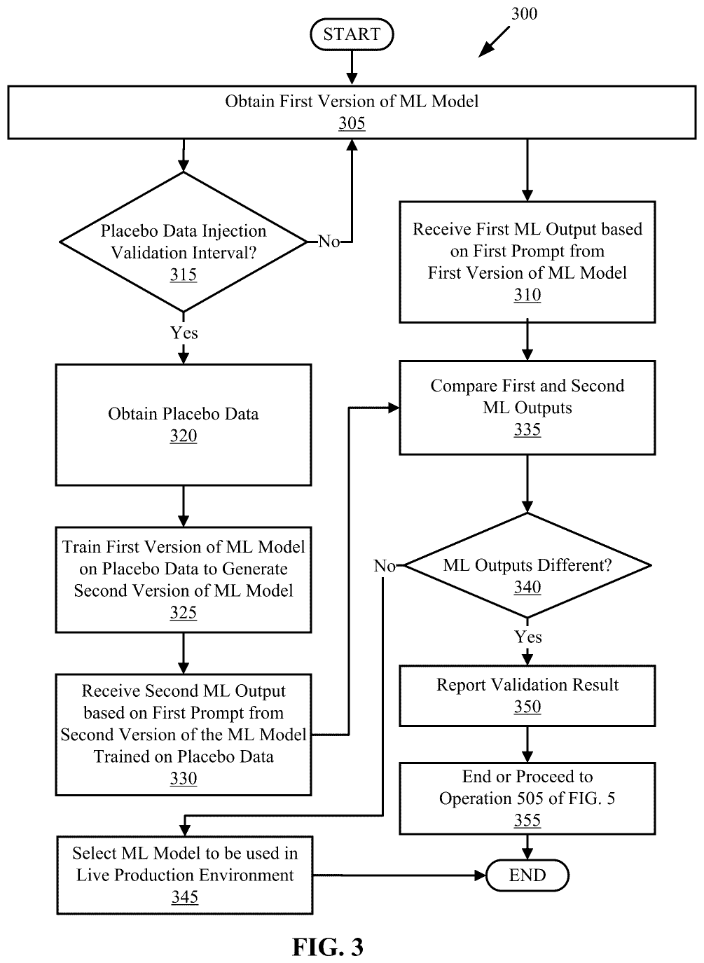

The MMGS 205 can be configured to determine whether placebo data injection validation (e.g., such as method 300 of FIG. 3) of an ML model should be performed. In embodiments, determining that placebo data injection validation should be performed is dependent on training intervals of an ML model. For example, if an ML model is trained during training intervals (e.g., in a batch fashion, using batches of training data 285), MMGS 205 can be configured to determine that placebo data injection validation should be completed during particular training intervals. For example, placebo data injection validation can be performed each training interval, every other training interval, or any suitable other training interval timing (e.g., every third training interval, every fifth training interval, every tenth training interval, etc.). In embodiments, training intervals of an ML model can be dependent on time, amount of new training data the ML model has ingested, and/or in response to specific user requests.

In embodiments where an ML model is continuously trained based on available operational training data, placebo data injection validation can occur at any suitable timing, such as continuously for any given ML model update (e.g., placebo data injection validation can continuously be performed in real-time when a ML model parameter change occurs), periodically (e.g., every hour, every day, etc.), intermittently, or over any other suitable timing. In embodiments, placebo data injection validation may occur if a ML model is updated in a substantial manner (e.g., a parameter of the ML model changes by a threshold amount, one or more layers are added to or removed from the ML model, the size of the ML model changes by a threshold amount, etc.). As discussed herein, a “placebo data injection validation interval” refers to a timing (e.g., scheduled or dynamically determined) in which placebo data injection validation is performed.

In embodiments, a secondary ML model (e.g., stored within ML model versions 280) can be trained to determine an appropriate placebo data injection validation interval based on factors associated with the ML model to be validated. Factors considered by the secondary ML model for adjusting the placebo data injection validation interval include the use frequency of the ML model (e.g., how often ML outputs are generated), maturity of the ML model (e.g., how long the ML model has been implemented/trained and the extent/thoroughness of training), training interval/timing of the ML model (e.g., the ML model is updated every month versus every day), and other factors. The secondary ML model can be trained on the above example factors of historical ML models where the placebo data injection validation interval has been determined/adjusted in the past. Selecting a shorter placebo data injection validation interval expends more processing resources but may prevent ML model drift to a state where it can be difficult to ascertain causes of ML model degradation (e.g., parameter changes/version implementations that caused or contributed to ML model degradation). Conversely, selecting a longer placebo data injection validation interval can conserve processing resources, but may risk ML model drift to a state where it is difficult to ascertain causes of ML model degradation. The secondary ML model can be trained to ascertain a placebo data injection validation interval that is ideal (e.g., best, optimal, etc. as decided by the secondary ML model) for a given ML model, to enable detection of ML model drift and/or identification of ML model degradation causes without performing placebo data injection validation too frequently such that unnecessary computing resources are consumed.

If MMGS 205 determines that a condition is met for placebo data injection validation, a placebo data injection validation method is performed. Placebo data injection validation includes training the ML model (e.g., a first version of the ML model) with placebo data to obtain (e.g., generate) a second version of the ML model trained on the placebo data. Placebo data injection validation further includes comparing ML outputs (e.g., a first ML output and a second ML output) between the original version (e.g., first version) of the ML model and the second version of the ML model trained on placebo data based on the same (or substantially similar) prompts. As referenced herein “placebo data” refers to training data that should have no effect on ML outputs based on the same or substantially similar prompts if the ML model is trained on the placebo data. For example, training ML prediction models or ML recommendation models on placebo data should result in no changes in predictions and/or recommendations received based on the same or similar prompts. If an ML output changes after training via injection of placebo data (e.g., using the same or a substantially similar prompt), this can indicate that the ML model is degraded and/or parameters of the ML model are incorrect. For example, this can indicate risk for hallucinations or other adverse responses by the ML model during regular training. In embodiments, this can indicate hyperparameters of the ML model being validated may be incorrect.

Placebo data module 215 can be configured to generate a placebo token 212 in response to determining that placebo injection training validation is to be performed (e.g., a condition is met for placebo injection training validation, such as the conditions discussed above). The placebo token 212 is a data object that represents a unique identifier associated with a given placebo data injection validation session. In embodiments, the placebo token 212 may identify the version of the ML model that is being validated, identify a storage location (e.g., one or more storage locations) where the version of the ML model that is being validated is stored, indicate a timestamp associated with the generation of the placebo token 212, indicate timestamps associated with a processing start and a processing end of the placebo data injection validation session, indicate a total processing time associated with the placebo data injection validation session, indicate deltas of model parameters that are incurred during the placebo data injection validation session, identify an updated version of the ML model after being trained on placebo data, identify a storage location (e.g., one or more storage locations) where the updated version of the ML model trained on placebo data is stored, and store/indicate other data associated with the placebo data injection validation session. In embodiments, multiple ML models may correspond to a single placebo token 212 (e.g., for multiple ML models making up an ensemble ML model). Alternatively, in embodiments, multiple placebo tokens 212 may correspond to a single ML model (e.g., data required to be stored exceeds the limit of a single placebo token 212).

In embodiments, the placebo token 212 can be or include a cryptographic hash, encryption key, or password required to perform the placebo data injection validation session. For example, upon generation of a placebo token 212, to initiate the placebo data injection validation session, a user may be required to provide the placebo token 212, a hash associated with the placebo token 212, a password associated with the placebo token 212, an encryption key associated with the placebo token 212, or other authorization techniques to cause placebo data injection validation. In embodiments, the placebo token 212 may only be transmitted to an authorized user (e.g., client 255) through a secure channel. In embodiments, the placebo token 212 is not necessary to initiate the placebo data injection validation session, and is stored as a data object that includes information associated with the placebo data injection validation session. Users can reference placebo token 212 identifiers to inspect information associated with specific placebo data injection validation sessions.

The placebo data module 215 can be configured to receive, select, generate, request, or otherwise obtain placebo data 214. In embodiments, the placebo data module 215 obtains placebo data 214 from training data 285. The training data 285 may be labeled or unlabeled operational training data used to train ML models. In embodiments, the placebo data 214 obtained from training data 285 is data which has been identified to have no effect (e.g., no adverse effect, no significant effect, etc.) on ML model parameters and/or ML outputs once the ML model has been trained on such data for the same or substantially similar prompts. Thus, the placebo data module 215 can be configured to select placebo data 214 from training data 285 based on whether it has previously affected the ML model (e.g., updated ML model parameters and/or ML outputs). In embodiments, the placebo data module 215 can be configured to generate placebo data 214. Generating placebo data 214 can include generating data that is the same as, or substantially similar to, historical training data 285 that has not impacted ML model parameters and/or ML model outputs based on the same or substantially similar prompts. In embodiments, generated placebo data 214 may not correspond to or relate to any historical training data 285 and may be manufactured for the purpose of validating an ML model. Other manners for obtaining placebo data 214 may be completed without departing from the spirit and scope of the present disclosure.

Placebo data injector 220 can be configured to inject placebo data 214 (e.g., provide placebo data 214 as training data) into a particular version of an ML model that is being validated via placebo data injection validation. This can include providing placebo data 214 to ML model trainer 210 such that ML model trainer 210 can train the ML model using the placebo data 214 to obtain a second version of the ML model (e.g., a version of the ML model trained on the placebo data 214). Additionally or alternatively, placebo data injector 220 can perform ML model training itself using the placebo data 214, where the placebo data 214 is provided to a ML model such that the ML model learns from the placebo data 214. It is noted that training a ML model on placebo data 214 may not necessarily update model parameters of the ML model being trained. That is, the ML model can be trained on the placebo data 214 without resulting in any modifications to the ML model (e.g., the original ML model may have the same parameters (e.g., weights/layers/values) as the updated ML model trained on placebo data 214). This may occur as placebo data 214 is selected as training data that should not have a significant impact on the ML model (e.g., the placebo data 214 should have a benign effect during training). However, in embodiments, training an ML model on placebo data 214 does update model parameters. The fact that a ML model parameter is updated does not necessarily mean the ML model is degraded or otherwise will output different ML outputs than the original ML model. In embodiments, training a ML model on placebo data 214 may result in minor changes to parameters, such as weights, layers, or other characteristics of the ML model, without resulting in degraded performance, degraded ML model architecture, and/or different ML outputs.

The prompt provider 225 can be configured to provide one or more prompts to ML model versions 280. ML model versions 280 can include ML model versions that have been updated over time through routine training and ML models that have been trained on placebo data 214, among other ML models. ML model versions 280 can be stored within datastore 275 in any suitable format (e.g., JavaScript® Object Notation (JSON), comma-separated value (CSV), TensorFlowJavaScript (TFJS), PyTorch®, Deep Learning Container (DLC), and many other suitable formats). The prompts can be received from prompt inputs 260 and 270 of clients 255 and 265. During placebo data injection validation, the prompt provider 225 can be configured to provide the same, or substantially similar, prompt(s) to an ML model trained on placebo data 214 that were provided to the ML model prior to training on placebo data 214. This enables the MMGS 205 to determine whether training the ML model on placebo data 214 results in different ML outputs between the ML model versions 280, which can indicate model degradation and adverse ML model parameter changes.

ML output receiver 230 can be configured to receive ML model outputs. ML model outputs are responses (e.g., answers), provided by a trained ML model, to prompts provided by the prompt provider 225. An ML model output can be obtained for each prompt that is provided to an ML model. For example, if a first set of prompts is provided to a first version of an ML model, a first set of ML model outputs can be received, where each ML model output corresponds to a respective prompt. Similarly, if the first set of prompts is provided to a second version of an ML model (e.g., an updated ML model trained on placebo data 214), a second set of ML model outputs can be received, where each ML output of the second set of ML model outputs corresponds to a respective prompt.

Any suitable number of prompts, type of prompts, and/or format of prompts can be provided to ML models (e.g., to be used for the purpose of placebo data injection validation) discussed herein without departing from the spirit and scope of the present disclosure. As discussed herein, a “substantially similar prompt” refers to a prompt which is similar to another prompt by a threshold amount (e.g., within a tolerance). For example, a tolerance for determining whether two prompts are substantially similar can be set based on factors such as character changes (e.g., one character difference is tolerated, multiple character changes are tolerated, etc.), word changes, synonym replacements, number changes, language translations, format differences, and other factors. For example, if a tolerance is set to permit a single character change, addition, or subtraction, then two prompts that would be considered substantially similar are “Why is my subscription canceled?” and “Why is my subscription cancelled?”, as they are the same prompts but for a single character difference, “1.” Two prompts that are considered “substantially similar” can be referred to as the same prompt. Following the example above, the prompts “Why is my subscription canceled?” and “Why is my subscription cancelled”? can be referred to as a “first prompt.” Thus, when referring to specific prompts (e.g., a first prompt, a second prompt, etc.) sent to specific ML models, the prompts do not have to be identical to be considered the same prompt for labeling purposes (e.g., “a first prompt” can be provided to two respective ML models with variations in wording/alphanumeric characters based on a tolerance).

Similarly, tolerances can be used when prompts include data that is not in a textual format. For example, if a prompt is in an image format, tolerances can enable differences in characteristics associated with the input images, such as pixel color differences, resolution differences, size differences, object differences, and feature differences (e.g., shapes, lines, curves, etc.). Thus, two prompts that include different respective images may be considered the same prompt if the images satisfy a tolerance.

The ML output comparator 235 can be configured to compare ML outputs between different ML model versions 280 for the same, or substantially similar, prompts. Comparison of ML model outputs can include comparing the response output by each ML model (e.g., a first, original, version of the ML model and a second version of the ML model trained on placebo data 214) to determine whether they are the same ML model outputs or substantially similar ML model outputs. As discussed herein, a “substantially similar ML output” can refer to an ML output which satisfies a tolerance with respect to another ML output. For example, for textual ML outputs, tolerances can be set based on factors such as character changes (e.g., a tolerated “X” number of character changes (where “X” is an integer)), word changes (e.g., a tolerated “Y” number of word changes (where “Y” is an integer)), number changes, synonym replacements, language translations, etc. As an example, if a tolerance for determining whether two ML model outputs are substantially similar permits synonym replacements, a first ML output “Your subscription is canceled due to an expired payment method” would be considered substantially similar to “Your subscription is terminated due to an expired payment method,” due to the ML outputs being the same but for the synonyms “canceled” and “terminated.” Thus, two ML model outputs that are within a tolerance (e.g., are substantially similar) may be referred to as the same ML model outputs (e.g., a first ML output) for the purpose of placebo data injection validation.

In embodiments where ML outputs include image data, tolerances can be set based on features/characteristics associated with the output images. For example, two images containing the same set of objects (e.g., a first object, a second object, and a third object), however oriented/sized/shaped, may be considered “substantially similar” for the purposes of determining whether the ML outputs are the same. As another example, images can be considered substantially similar based on image characteristics such as pixel color, color composition, image resolution, image size, and image features (e.g., patterns, shapes, etc.) satisfying a tolerance. Any suitable number of image characteristics can be considered for the purpose of determining whether images output by ML models are substantially similar. Further, any suitable tolerance can be implemented for the purpose of determining whether images output by ML models are substantially similar.

If a first ML output (or first set of ML outputs) produced by a first version of an ML model based on a first prompt is the same as (or substantially similar to) a second ML output (or a second set of ML outputs) produced by a second version of an ML model based on the first prompt, the ML output comparator can determine that the first version of the ML model is validated (e.g., not degraded). If the first ML output (or first set of ML outputs) produced by the first version of the ML model based on the first prompt is different than (e.g., not substantially similar to) the second ML output (or the second set of ML outputs) produced by the second version of the ML model based on the first prompt, the ML output comparator can determine that the first version of the ML model is not validated (e.g., degraded). The result of the comparison performed by the ML output comparator 235 can be referred to as (or used to infer or otherwise determine) a “validation result.” Example favorable validation results include “validated,” “not degraded,” and “the same ML outputs.” Example unfavorable validation results include “not validated,” “degraded,” and “different ML outputs.” Validation results can be output in any suitable format without departing from the spirit and scope of the present disclosure. A validation result generally refers to a classification (e.g., label) associated with placebo injection training validation.

The comparison result reporter 240 can be configured to transmit the validation result determined by the ML output comparator 235. The comparison result reporter 240 can transmit the validation result to any suitable computing device using any communication technique, such as those described with respect to FIG. 1. For example, comparison result reporter 240 can transmit validation results to clients 255 and 265 via an application, a web browser, email, a text message, and other communication techniques. In embodiments, the validation result is transmitted to subscribers (e.g., users) of an ML model. In embodiments, the validation result is transmitted to an ML model administrator or engineer responsible for adjusting or otherwise managing the ML model (e.g., an individual that manages hyperparameters and parameters of the ML model). In embodiments, the comparison result reporter 240 can be configured to store a log of the ML model versions (e.g., the first ML model version and second ML model versions) including the validation result. The log can be stored within datastore 275 and/or be associated with the placebo token 212 for the placebo data injection validation session.

The ML model analysis and adjustment module 247 can be configured to analyze the ML models (e.g., the first and second versions of the ML model) and adjust ML model parameters based on the analysis. In embodiments, ML model analysis and adjustment is performed responsive to a validation result indicating that a ML model is degraded (e.g., an unfavorable validation result). In embodiments, ML model analysis and adjustment does not necessarily have to occur in response to receiving a validation result. That is, ML model analysis and adjustment can be completed without receiving or reporting a validation result and may be completed based on a comparison between the ML outputs received from the first and second versions of the ML model (e.g., based on the ML outputs from each respective model being different). ML model analysis can include analyzing the first version of the ML model with respect to the second version of the ML model to determine changes to parameters (e.g., weights, layers, and other characteristics) of the first version of the ML model that resulted in the second version of the ML model.

In embodiments, ML model adjustment can include reverting the first version of the ML model to a previous version. In such embodiments, a previous version of the ML model that had a favorable validation result (e.g., validated, not degraded, no ML output difference, etc.) can be selected as an ML model for reversion to. In embodiments, the version of the ML model to be reverted to can be selected by a user, such as an ML model administrator or engineer. In embodiments, a secondary ML model can be configured to determine a suitable previous ML model version that the ML model should be reverted to. However, any suitable manner for selecting a previous ML model that the ML model should be reverted to can be completed.

In embodiments, the ML model adjustment can include additional training of the ML model. For example, in response to an unfavorable validation result (e.g., degraded), ML model analysis and adjustment module 247 can be configured to re-train the first version of the ML model to attempt to correct the ML model. In embodiments, ML model adjustment can include modifying hyperparameters of the first version of the ML model.

In embodiments, the ML model adjustment can include modifications made to specific parameters, such as weight values, of the first ML model that changed a result in the second version of the ML model trained on placebo data 214. For example, in response to an unfavorable validation result (e.g., degraded), ML model analysis and adjustment module 247 can be configured to determine at least one parameter of the first version of the ML model that changed to result in the second version of the ML model trained on placebo data 214 and adjust the at least one parameter that changed. The specific change made to the ML model parameter can vary. For example, the ML model parameter can be reverted to a previous value, assigned a lower weight (e.g., resulting in less impact on the ML models outputs), removed, or changed by a particular amount (e.g., based on a threshold).

In embodiments, in response to receiving a favorable validation result, the second version of the ML model trained on placebo data 214 can be launched in a live production environment (e.g., used in a business, enterprise, personally, and/or other capacity). Conversely, responsive to receiving a favorable validation result, the first version of the ML model can be launched in the live product environment. The ML model launched in the live production environment can continue to be trained, either during training intervals or continuously.

It is noted that FIG. 2 is intended to depict the representative major components of an example computing environment 200. In some embodiments, however, individual components can have greater or lesser complexity than as represented in FIG. 2, components other than or in addition to those shown in FIG. 2 can be present, and the number, type, and configuration of such components can vary.

Referring now to FIG. 3, shown is a flowchart of an example method 300 for ML model governance using placebo data injection validation, in accordance with embodiments of the present disclosure. One or more operations of method 300 can be completed by one or more processing circuits (e.g., computer 101, end user device 103, remote server 104, clients 255/265, MMGS 205, datastore 275, etc.).

Method 300 initiates at operation 305, where a first version of an ML model is obtained. The first version of the ML model can be obtained in the same, or a substantially similar manner, as described with respect to the MMGS 205 and ML model trainer 210 of FIG. 2. The first version of the ML model may be referred to as “the original version of the ML model,” for the purpose of distinguishment from the “second ML model” which is trained on placebo data. The type of training, initial hyperparameters and parameters of the first version of the ML model, maturity of the first version of the ML model, and use frequency of the first version of the ML model can vary.

A first ML output is received from the first version of the ML model based on a first prompt. This is illustrated at operation 310. Receiving the first ML output can be completed in the same, or a substantially similar manner, as described with respect to the ML output receiver 230 of FIG. 2. In embodiments, operation 310 is completed responsive to determining that there is a placebo data injection validation interval at operation 315 (e.g., operation 310 can occur before, during, or after operations 320-330).

A determination is made whether there is a placebo data injection validation interval. This is illustrated at operation 315. Determining whether there is a placebo data injection validation interval can be completed in the same, or a substantially similar manner, as described with respect to the MMGS 205. If there is not a placebo data injection validation interval, then method 300 may return to operation 305 until a placebo data injection validation interval is determined.

If there is a placebo data injection validation interval, then placebo data is obtained at operation 320. Obtaining placebo data can be completed in the same, or a substantially similar manner, as described with respect to the placebo data module 215 of FIG. 2

The first version of the ML model is then trained using the placebo data to generate a second version of the ML model. This is illustrated at operation 325. Training the first version of the ML model using the placebo data can be completed in the same, or a substantially similar manner, as described with respect to the ML model trainer 210 and placebo data module 215 of FIG. 2.

A second ML output is received from the second version of the ML model trained on placebo data based on the first prompt. This is illustrated at operation 330. As discussed above, the “first prompt” of operation 330 does not necessarily have to be exactly the same as the “first prompt” of operation 310, depending on tolerated variance between prompts.

The first ML output received from the first version of the ML model (obtained at operation 310) and the second ML output received from the second version of the ML model (obtained at operation 330) are compared. This is illustrated at operation 335. Comparing the ML outputs can include comparing text-based, image-based, or other format ML outputs provided by the first and second versions of the ML models. In embodiments, determining whether two ML outputs produced by respective ML versions are the same can be based on a tolerance. That is, a certain amount and/or type of changes may be tolerated between the first ML output and the second ML output without designating the ML outputs as different.

A determination is made whether the ML outputs are different. This is illustrated at operation 340. If a determination is made that the ML outputs are not different (e.g., are the same or substantially similar), then method 300 proceeds to operation 345 where a version of the ML model is selected (e.g., between the first and second versions) to be used in a live production environment. In embodiments, the first version of the ML model can be considered validated and launched in a live production environment due to the favorable validation result. However, in embodiments, the second version of the ML model can be launched in the live production environment instead. This is because the second version of the ML model may not have been negatively affected (or was potentially positive affected) as a result of the placebo data training. In embodiments, the validation result can be reported in instances where the validation result is favorable.

If a determination is made that the ML outputs are different (e.g., are not the same or are not substantially similar), then method 300 proceeds to operation 350, where the validation result is reported. Reporting the validation result can be completed in the same, or a substantially similar manner, as described with respect to comparison result reporter 240 of FIG. 2. In embodiments, the validation result can be reported when the validation result is favorable (e.g., at operation 345).

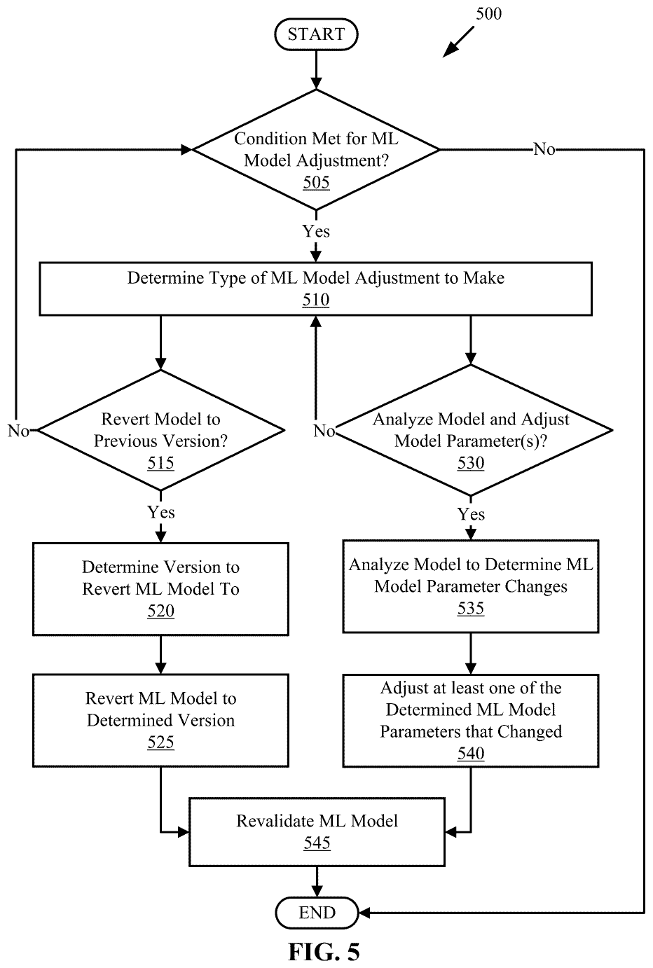

Method 300 can then optionally end after reporting the validation result at operation 355. Method 300 can alternatively proceed to operation 505 of FIG. 5 for adjusting the first version of the ML model or second version of the ML model based on the unfavorable validation result.

The aforementioned operations can be completed in any order and are not limited to those described. Additionally, some, all, or none of the aforementioned operations can be completed, while still remaining within the spirit and scope of the present disclosure.

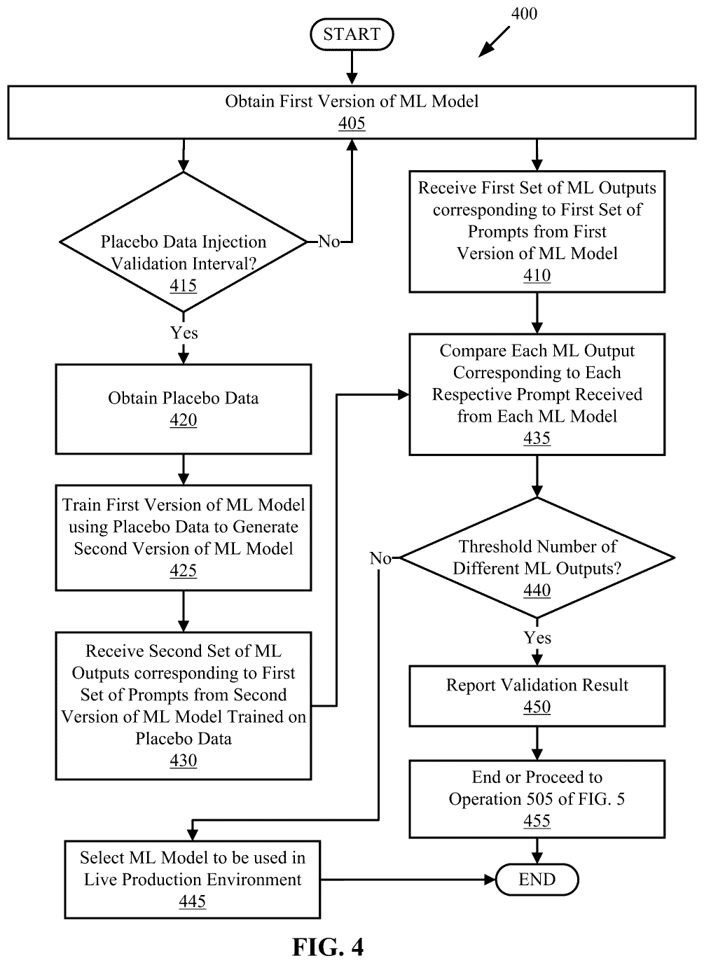

Referring now to FIG. 4, shown is a flowchart of another example method 400 for ML model governance using placebo data injection validation, in accordance with embodiments of the present disclosure. One or more operations of method 400 can be completed by one or more processing circuits (e.g., computer 101, end user device 103, remote server 104, clients 255/265, MMGS 205, datastore 275, etc.).

Method 400 initiates at operation 405, where a first version of an ML model is obtained. The first version of the ML model can be obtained in the same, or a substantially similar manner, as described with respect to the MMGS 205 and ML model trainer 210 of FIG. 2. The first version of the ML model may be referred to as “the original version of the ML model,” for the purpose of distinguishment from the “second ML model” which is trained on placebo data. The type of training, initial hyperparameters and parameters of the first version of the ML model, maturity of the first version of the ML model, and use frequency of the first version of the ML model can vary.

A first set of ML outputs is received from the first version of the ML model based on a first set of prompts. This is illustrated at operation 410. Receiving the first set of ML outputs can be completed in the same, or a substantially similar manner, as described with respect to the ML output receiver 230 of FIG. 2. Prompts within the first set of prompts can vary (e.g., be directed to different subject matter, request different types of results (images vs text), be sent at different times, etc.). Each prompt within the first set of prompts receives a corresponding (e.g., respective) ML output. For example, if a set of prompts includes two prompts: “What time is it in Japan?” and “Show me an image of an analog clock with the correct time in Japan,” a first ML output of the first set of ML outputs could be an answer to the first prompt (e.g., “The time in Japan is 12:00.”) and a second ML output of the first set of ML outputs could be an image depicting the analog clock in Japan showing the time as 12:00, as generated by the ML model (e.g., a generative ML model). Thus, in this example, the first prompt of the first set of prompts has a corresponding first ML output of the first set of ML outputs and the second prompt of the first set of prompts has a corresponding second ML output of the first set of ML outputs.

In embodiments, operation 410 is completed responsive to determining that there is a placebo data injection validation interval at operation 415. In embodiments, operation 410 can be completed prior to, during, or after operations 420-430.

A determination is made whether there is a placebo data injection validation interval (e.g., whether a condition is met for placebo data injection validation). This is illustrated at operation 415. Determining whether there is a placebo data injection validation interval can be completed in the same, or a substantially similar manner, as described with respect to the MMGS 205. If there is not a placebo data injection validation interval, then method may return to operation 405 until a placebo data injection validation interval is determined.

If there is a placebo data injection validation interval, then placebo data is obtained at operation 420. Obtaining placebo data can be completed in the same, or a substantially similar manner, as described with respect to the placebo data module 215 of FIG. 2

The first version of the ML model is then trained using the placebo data to generate a second version of the ML model. This is illustrated at operation 425. Training the first version of the ML model using the placebo data can be completed in the same, or a substantially similar manner, as described with respect to the ML model trainer 210 and placebo data module 215 of FIG. 2.

A second set of ML outputs is received from the second version of the ML model trained on placebo data based on the first set of prompts. This is illustrated at operation 430. As discussed above, the “first set of prompts” of operation 430 does not necessarily have to be exactly the same as the “first set of prompts” of operation 410, depending on tolerated variance between prompts. Each prompt within the first set of prompts receives a corresponding (e.g., respective) ML output. For example, if a set of prompts includes two prompts: “What is the weather like this evening?” and “Show me what the weather will look like this evening,” a first ML output of the second set of ML outputs could be an answer to the first prompt (e.g., “The weather will be rainy this evening.”) and a second ML output of the second set of ML outputs could be an image depicting what the weather will look like this evening, as generated by the ML model (e.g., a generative ML model). Thus, in this example, the first prompt of the first set of prompts has a corresponding first ML output of the second set of ML outputs and the second prompt of the first set of prompts has a corresponding second ML output of the second set of ML outputs.

The first set of ML outputs received from the first version of the ML model (obtained at operation 410) and the second set of ML outputs received from the second version of the ML model (obtained at operation 430) are compared. This is illustrated at operation 435. Comparing the first set of ML outputs and the second set of ML outputs can include comparing respective text-based, image-based, or other format ML outputs provided by the first and second versions of the ML models. In embodiments, determining whether two ML outputs produced by respective ML versions are the same can include tolerances. That is, a certain amount and/or type of changes may be tolerated between the first ML output and the second ML output without designating the ML outputs as different. ML outputs within each set received from each ML model version are compared to their corresponding counterpart output in the other ML output set. For example, if a first set of ML outputs received from the first version of the ML model includes three outputs: Output 1, Output 2, and Output 3, and a second set of ML outputs received from the second version of the ML model trained on placebo data includes three outputs: Output 4, Output 5, and Output 6, Output 1 would be compared to Output 4 (corresponding to a first prompt of the first set of prompts), Output 2 would be compared to Output 5 (corresponding to a second prompt of the first set of prompts), and Output 3 would be compared to Output 6 (corresponding to a third prompt of the first set of prompts).

A determination is made whether a threshold number of ML outputs are different between the first set of ML outputs and the second set of ML outputs. This is illustrated at operation 440. As an example, if a threshold is set such that 30% of ML outputs are permitted to differ between the ML output sets, if eight out of ten ML outputs are the same between the first and second set of ML outputs, then a determination is made that there is not a threshold number of different ML outputs (only 20% of ML outputs differ). In contrast, if only six out of ten ML outputs are the same between the first and second set of ML outputs, then a determination is made that there is a threshold number of different ML outputs (40% of ML outputs differ). Any suitable threshold can be implemented for comparing ML outputs for the purpose of placebo data injection validation. For example, the threshold can be set based on a number of permitted different ML outputs or a percentage of different ML outputs. In embodiments, all ML outputs may be required to be the same (e.g., 0% of ML outputs are permitted to differ). In embodiments, only a single ML output may be required to be the same. In embodiments, only a single ML output may be required to be different. However, threshold/conditions for determining whether ML output sets are acceptable for validation purposes can vary.

If a determination is made that there is not a threshold number of different ML outputs (e.g., there is a favorable validation result), then method 400 proceeds to operation 445 where a version of the ML model is selected (e.g., between the first and second versions) to be used in a live production environment. In embodiments, the first version of the ML model can be considered validated and launched in a live production environment due to the favorable validation result. However, in embodiments, the second version of the ML model can be launched in the live production environment instead. This is because the second version of the ML model may not have been negatively affected (or was potentially positive affected) as a result of the placebo data training. In embodiments, the validation result can be reported in instances where the validation result is favorable.

If a determination is made that there is a threshold number of different ML outputs (e.g., there is an unfavorable validation result), then method 400 proceeds to operation 450 where the validation result is reported. Reporting the validation result can be completed in the same, or a substantially similar manner, as described with respect to comparison result reporter 240 of FIG. 2.

Method 400 can then optionally end after reporting the validation result at operation 455. Method 400 can alternatively proceed to operation 505 of FIG. 5 for adjusting the first version of the ML model or second version of the ML model based on the unfavorable validation result.

The aforementioned operations can be completed in any order and are not limited to those described. Additionally, some, all, or none of the aforementioned operations can be completed, while still remaining within the spirit and scope of the present disclosure.

Referring now to FIG. 5, shown is a flowchart of an example method 500 for ML model adjustment based on a placebo data injection validation result, in accordance with embodiments of the present disclosure. One or more operations of method 500 can be completed by one or more processing circuits (e.g., computer 101, end user device 103, remote server 104, clients 255/265, MMGS 205, datastore 275, etc.).

Method 500 initiates at operation 505, where a determination is made whether a condition is met for ML model adjustment. This is illustrated at operation 505. Conditions for determining that a ML model adjustment is to be completed vary. In embodiments, conditions for determining that a ML model adjustment is to be completed can include receiving an unfavorable validation result from a performed placebo data injection validation, identifying a ML model parameter change that satisfies a threshold, and/or receiving a request for ML model adjustment, among others. In embodiments, a version of a ML model to make an adjustment to is determined prior to operation 505 (e.g., whether the first version of the ML model or second version of the ML model trained on placebo data will be modified and launched in a live production environment). If a condition is not met for ML model adjustment, method 500 ends.

A type of model adjustment to make is determined. This is illustrated at operation 510. Types of model adjustments to make can vary and are not exhaustively discussed with respect to FIG. 5. Example types of ML model adjustments include re-training a version of an ML model (e.g., the first version or second version, not shown in FIG. 5), reverting the ML model to a previous version (e.g., selecting a previous version of the ML model to revert the ML model to) as in operations 515-525, receiving a request for a specific ML model change (e.g., a request for a hyperparameter or parameter change by an ML model administrator/engineer, not shown in FIG. 5), and analyzing a ML model (e.g., the first version of second version) and adjusting model parameters as in operations 530-540.

If a determination is made that the ML model should be reverted to a previous version in operation 515, a version of the ML model to be reverted to is determined. This is illustrated at operation 520. In embodiments, the version the ML model is to be reverted to is determined based on a previous favorable validation result (e.g., an ML model version that was not indicated as degraded and has been determined to be properly operating). For example, placebo tokens 212 associated with previous placebo data injection validation sessions can be inspected to determine a last placebo token 212 (e.g., chronologically) that had a favorable validation result. The ML model version associated with the last placebo token 212 can then be selected as the ML model version for reversion. In embodiments, a previous ML model version to be reverted to can be manually selected by an ML model administrator/engineer. The ML model is then reverted to the determined previous version. This is illustrated at operation 525. If a determination is made, at operation 515, that the ML model should not be reverted to a previous version, method 500 may return to operation 505, or alternatively, operation 510.

If a determination is made that the type of ML model adjustment to make is analyzing the ML model and adjusting ML model parameters at operation 530, then the ML model is analyzed to determine ML model parameter changes. This is illustrated at operation 535. Determining ML model parameter changes can include inspecting the first version of the ML model with respect to the second version of the ML model trained on placebo data to identify all parameters that have changed between the first version of the ML model and the second version of the ML model. Thus, operation 535 can return a list of changed ML model parameters, values of ML model parameters that changed, new ML model parameters that have been added, and/or ML model parameters that have been removed. If a determination is made that the ML model should not be analyzed and have its parameters adjusted at operation 530, method 500 may return to operation 510, or alternatively, operation 505.

At least one of the determined ML model parameters that changed are then adjusted. This is illustrated at operation 540. Adjusting ML model parameters can be completed in the same, or a substantially similar manner, as discussed with respect to the ML model analysis and adjustment module 247 of FIG. 2. For example, adjusting ML model parameters can include adding ML model parameters (e.g., that were removed from the first version of the ML model), changing ML model parameter values (e.g., reverting to a previous value, changing a parameter value by a certain amount, reducing a weight associated with a parameter value), and removing ML model parameters (e.g., that were added to the second version of the ML model). Adjusting the ML model can result in a third version of the ML model (e.g., a modified version of the first or second ML model). In embodiments, the manner for adjusting ML model parameters depends on whether the ML model selected to be modified/launched is the first ML model version or the second ML model version. Manners for adjusting ML models can vary without departing from the spirit and scope of the present disclosure.

Upon adjusting the ML model (e.g., at operations 525 and 540 or in other manners not shown in FIG. 5), the ML model (e.g., a third version of the ML model) can optionally be revalidated at operation 545. This can include additional placebo data injection validation iterations. That is, a second placebo data injection validation method (e.g., or third, fourth, fifth, etc.) can be performed on the third version of the ML model to receive a second validation result. This can also include other manners for validating ML models, such as cross-validation using k-folds, leave-one-out cross-validation, leave-one-group-out cross validation, nested cross-validation, cross-validation for time-series data, and stratified k-fold cross-validation, among others. In embodiments, upon revalidating the adjusted ML model at operation 545, the revalidated model can be implemented (e.g., launched) in a live production environment.

The aforementioned operations can be completed in any order and are not limited to those described. Additionally, some, all, or none of the aforementioned operations can be completed, while still remaining within the spirit and scope of the present disclosure.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Advantages discussed in the present disclosure are example advantages, and embodiments of the present disclosure can exist that realize all, some, or none of any of the discussed advantages while remaining within the spirit and scope of the present disclosure.

Although the present disclosure has been described in terms of specific embodiments, it is anticipated that alterations and modification thereof will become apparent to those skilled in the art. Therefore, it is intended that the following claims be interpreted as covering all such alterations and modifications as fall within the true spirit and scope of the disclosure.

What is claimed is:

1. A computer-implemented method comprising:
receiving a first machine learning (ML) output from a first version of a ML model based on a first prompt;
training the first version of the ML model on placebo data to obtain a second version of the ML model;
receiving a second ML output from the second version of the ML model trained on the placebo data based on the first prompt; and
receiving a validation result based on a comparison between the first ML output and the second ML output.

2. The method of claim 1, wherein training the first version of the ML model to obtain the second version of the ML model, receiving the second ML output, and receiving the validation result are completed in response to determining that a condition is met for performing a placebo data injection validation method.

3. The method of claim 2, wherein determining that the condition is met for performing the placebo data injection validation method includes determining that the first version of the ML model was updated during a first training interval.

4. The method of claim 2, wherein determining that the condition is met for performing the placebo data injection validation method includes determining that the first version of the ML model has a ML model parameter change during a last training update that satisfies a parameter change threshold.

5. The method of claim 1, wherein the validation result is an unfavorable validation result based on the first ML output and the second ML output being different.

6. The method of claim 5, further comprising:
adjusting, based on receiving the unfavorable validation result, the first version of the ML model.

7. The method of claim 6, wherein the adjusting further comprises:
determining a specific previous version that the first version of the ML model should be reverted to; and
reverting the first version of the ML model to the specific previous version.

8. The method of claim 6, wherein the adjusting further comprises:
analyzing the first version of the ML model with respect to the second version of the ML model trained on the placebo data to determine at least one ML model parameter that changed between the first version and the second version;
selecting a ML model parameter of the at least one ML model parameter that changed between the first version of the ML model and the second version of the ML model trained on placebo data within the first version of the ML model; and
adjusting the selected ML model parameter of the first version of the ML model to generate a third version of the ML model.

9. The method of claim 8, wherein the third version of the ML model is implemented into a live production environment.

10. A system comprising:
one or more processors; and
one or more computer-readable storage media collectively storing program instructions which, when executed by the one or more processors, are configured to cause the one or more processors to perform a method comprising:
receiving a first machine learning (ML) output from a first version of a ML model based on a first prompt;
training the first version of the ML model on placebo data to obtain a second version of the ML model;
receiving a second ML output from the second version of the ML model trained on the placebo data based on the first prompt; and
receiving a validation result based on a comparison between the first ML output and the second ML output.

11. The system of claim 10, wherein the validation result is an unfavorable validation result based on the first ML output and the second ML output being different.

12. The system of claim 11, wherein the one or more computer-readable storage media collectively store additional program instructions which, when executed by the one or more processors, are configured to cause the one or more processors to perform the method further comprising:
adjusting, based on receiving the unfavorable validation result, the first version of the ML model.

13. The system of claim 12, wherein the adjusting further comprises:
determining a specific previous version that the first version of the ML model should be reverted to; and
reverting the first version of the ML model to the specific previous version.

14. The system of claim 12, wherein the adjusting further comprises:
analyzing the first version of the ML model with respect to the second version of the ML model trained on the placebo data to determine at least one ML model parameter that changed between the first version and the second version;
selecting a ML model parameter of the at least one ML model parameter that changed between the first version of the ML model and the second version of the ML model trained on the placebo data within the first version of the ML model; and
adjusting the selected ML model parameter of the first version of the ML model to generate a third version of the ML model.

15. A computer program product comprising one or more computer readable storage media, and program instructions collectively stored on the one or more computer readable storage media, the program instructions comprising instructions configured to cause one or more processors to perform a method comprising:
receiving a first machine learning (ML) output from a first version of a ML model based on a first prompt;
training the first version of the ML model on placebo data to obtain a second version of the ML model;
receiving a second ML output from the second version of the ML model trained on the placebo data based on the first prompt; and
receiving a validation result based on a comparison between the first ML output and the second ML output.

16. The computer program product of claim 15, wherein the validation result is an unfavorable validation result based on the first ML output and the second ML output being different.

17. The computer program product of claim 16, wherein the program instructions include additional instructions that cause the one or more processors to perform:
adjusting, based on receiving the unfavorable validation result, the first version of the ML model.

18. The computer program product of claim 17, wherein the adjusting further comprises:
determining a specific previous version that the first version of the ML model should be reverted to; and
reverting the first version of the ML model to the specific previous version.

19. The computer program product of claim 17, wherein the adjusting further comprises:
analyzing the first version of the ML model with respect to the second version of the ML model trained on the placebo data to determine at least one ML model parameter that changed between the first version and the second version;
selecting a ML model parameter of the at least one ML model parameter that changed between the first version of the ML model and the second version of the ML model trained on the placebo data within the first version of the ML model; and
adjusting the selected ML model parameter of the first version of the ML model to generate a third version of the ML model.

20. A computer-implemented method comprising:
receiving a first set of machine learning (ML) outputs from a first version of a ML model based on a first set of prompts;
training the first version of the ML model on placebo data to obtain a second version of the ML model;
receiving a second set of ML outputs from the second version of the ML model trained on the placebo data based on the first set of prompts; and
receiving a validation result based on a comparison between the first set of ML outputs and the second set of ML outputs.

21. The method of claim 20, wherein the validation result is an unfavorable validation result based on a threshold number of ML outputs being different between the first set of ML outputs and the second set of ML outputs.

22. The method of claim 21, further comprising:
adjusting, based on receiving the unfavorable validation result, the first version of the ML model to obtain a third version of the ML model;
performing a second placebo data injection validation method on the third version of the ML model to receive a second validation result; and
implementing the third version of the ML model into a live production environment based on the second validation result being a favorable validation result.

23. A system comprising:
one or more processors; and
one or more computer-readable storage media collectively storing program instructions which, when executed by the one or more processors, are configured to cause the one or more processors to perform a method comprising:
receiving a first machine learning (ML) output from a first version of a ML model based on a first prompt;
training the first version of the ML model on placebo data to obtain a second version of the ML model;
receiving a second ML output from the second version of the ML model trained on the placebo data based on the first prompt; and
adjusting the first version of the ML model based the first ML output and the second ML output being different.

24. The system of claim 23, wherein adjusting the first version of the ML model comprises:
determining a specific previous version that the first version of the ML model should be reverted to; and
reverting the first version of the ML model to the specific previous version.

25. The system of claim 23, wherein adjusting the first version of the ML model comprises:
analyzing the first version of the ML model with respect to the second version of the ML model trained on the placebo data to determine at least one ML model parameter that changed between the first version and the second version;
selecting a ML model parameter of the at least one ML model parameter that changed between the first version of the ML model and the second version of the ML model trained on the placebo data within the first version of the ML model; and
adjusting the selected ML model parameter of the first version of the ML model to generate a third version of the ML model.
